(19) United States
(12) Patent Application Publication
(10) Pub. No.: US 2026/0298171 A1
(43) Pub. Date: Oct. 1, 2026

(54) FUEL LEAKAGE DIAGNOSTIC AND FUEL SYSTEM DIAGNOSTIC MANAGEMENT APPARATUSES, METHODS, AND SYSTEMS

(71) Applicant: Cummins-Scania HPCR System, LLC, Columbus, IN (US)

(72) Inventors: Michael R. Tidwell, Bloomington, IN (US); Sarah E. Gnau, Lexington, KY (US)

(21) Appl. No.: 19/489,782

(22) PCT Filed: May 22, 2024
(86) PCT No.: PCT/US2024/030540

§ 371 Date: Dec. 3, 2025

Related U.S. Application Data
(60) Provisional application No. 63/507,756, filed on Jun. 13, 2023.
(60) Provisional application No. 63/583,919, filed on Sep. 20, 2023.

(51) Int. Cl. F02D 41/22; F02M 65/00

(52) U.S. Cl. CPC F02D 41/22; F02M 65/003; F02M 65/006; F02D 2041/225

(57) ABSTRACT

A method of testing a fuel system of an engine includes determining a fuel amount used during a first test period to maintain a first fuel system pressure at an engine speed, and determining the fuel amount used during a second test period to maintain a second, higher fuel system pressure at the engine speed. The method includes diagnosing a condition of the fuel system in response to the difference between the fuel amounts. Management of the testing or diagnosing one or more conditions in a fuel system causing undesired performance are also disclosed.

### CROSS-REFERENCE TO RELATED APPLICATIONS:

The present application claims the benefit of the filing date of, and priority to, U.S. Provisional App. Ser. No. 63/507,756 filed on Jun. 13, 2023 and U.S. Provisional App. Ser. No. 63/583,919 filed Sep. 20, 2023, each of which is incorporated herein by reference.

### TECHNICAL FIELD

The present application relates to high pressure fuel systems, and more particularly to fuel leakage diagnostics and management of diagnostics for fuel systems and related apparatuses, methods, and systems.

### BACKGROUND

Identifying sources of leakage and other conditions causing undesirable operation of a high pressure fuel system can be difficult and time consuming. Over-repair of the fuel system may occur due to the technician unnecessarily replacing components and re-testing the fuel system to determine if the replaced component addressed the condition and, if not, replacing additional components until it is determined the condition has been repaired. As a result, repair times are extended and repair costs increase over what is required to repair only the components that are faulty. Therefore, there remains a significant unmet need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and method of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

One embodiment is a unique system for testing or diagnosing fuel leakage in a fuel system. Another embodiment is a unique method for testing or diagnosing a fuel system. Another embodiment is a unique apparatus for testing or diagnosing a high pressure leakage in a fuel system.

A further embodiment is a unique system for managing the testing or diagnosing one or more conditions in a fuel system causing undesired performance. Another embodiment is a unique method for managing the testing or diagnosing such conditions in a fuel system. Another embodiment is a unique apparatus for managing the testing or diagnosing of undesired conditions in a fuel system. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example system.

FIG. 2 is a schematic diagram illustrating certain aspects of an example method.

FIG. 3 is graph illustrating certain aspects of example operations of an example methods and systems.

FIG. 4 is a schematic diagram illustrating certain aspects of an example system including a fuel system for fueling an internal combustion engine.

FIG. 5 is a schematic diagram illustrating certain aspects of a process for managing diagnostic testing for the fuel system of FIG. 4.

FIG. 6 is a flow diagram of an example method for managing the diagnostic testing of the fuel system of FIG. 4.

### DETAILED DESCRIPTION OF EXAMPLE EMBODIMENTS

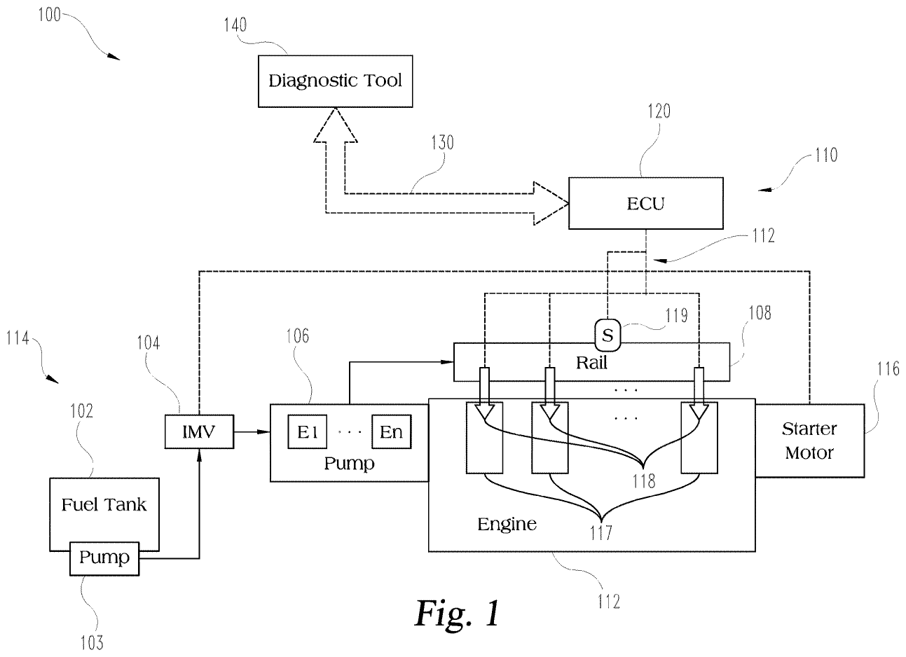

With reference to FIG. 1, there is illustrated a system 100 including a diagnostic tool 140 and an engine system 110. The diagnostic tool 140 may be selectably operatively coupled with and in operative communication with an electronic control unit (ECU) 120 of engine system 110 via one or more communication links 130. Diagnostic tool 140 and communication links 130 may be provided in a number of forms.

In some embodiments, diagnostic tool 140 may be implemented and executed in connection with one or more computing devices present at the location of engine system 110 (e.g., at a service bay or another point-of-service at which engine system 110 is located). In such embodiments, communication links 130 may include one more physical connections with engine system 110, for example, via an OBD II interface, a J1939 interface, or various other interfaces.

In some embodiments, diagnostic tool 140 may be implemented and executed in connection with one or more computing devices located remotely from engine system 110 and communication links 130 may include one more networks including wired and/or wireless networks or network components configured and operable to provide communication between diagnostic tool 140 and ECU 120 of engine system 110. Some such embodiments may include one or more computing devices located remotely from engine system 110 and in communication with ECU 120 of engine system 110 via a telematics system. Some such embodiments may include a combination of one or more computing devices located remotely from engine system 110 and one or more computing devices present at the location of engine system 110 (e.g., at a service bay or another point-of-service at which engine system 110 is located).

While diagnostic tool 140 is depicted in FIG. 1 as external to engine system 110, on some embodiments, diagnostic tool 140 may be embedded or otherwise provide in engine system 110. In some such embodiments, diagnostic tool 140 may be embedded or otherwise provide in and executed by ECU 120 and/or other components of an electronic control system (ECS) of engine system 110. In some such embodiments communication links 130 may include one or more intra-ECU or intra ECS communication channels or may be omitted in instances where a communication link is not required.

Engine system 110 further includes an engine 112, a starter motor 116 operatively coupled with engine 112 and ECU 120, and a fuel system 114 operatively coupled with engine 112 and ECU 120. In the illustrated embodiment engine 112 is a direct-injection, reciprocating piston-type internal combustion engine configured and operable to combust fuel injected by one or more fuel injectors 118 directly into one respective ones of a plurality of combustion cylinders 117. It shall be appreciated that engine 112 may be configured and provided in various forms including various numbers of combustion cylinders 117 and various numbers of fuel injectors 118.

In the illustrated embodiment, fuel system 114 is configured and provided as a high-pressure common-rail (HPCR) fuel system. In other embodiments, fuel system 114 may be provided in a various other forms as will occur to one of skill in the art with the benefit and insight of the present disclosure. Fuel system 114 includes a fuel rail 108 which receives pressurized fuel from a fuel pump 106 and provides pressurized fuel to fuel injectors 118. In the illustrated embodiment, fuel pump 106 is provided and configured as a high pressure fuel pump and includes one or more pump elements (E1 . . . En) such as piston-in-cylinder-type pump elements configured to pressurize fuel received by fuel pump 106.

In an embodiment, an inlet metering valve (IMV) 104 is provided at or upstream from an inlet to fuel pump 106 and is operatively coupled with and controllable by ECU 120 to meter or regulate flow of fuel into fuel pump 106. IMV 104 is configured and operable to received fuel pumped from fuel tank 102 by pump 103 which may be configured and provided as a low pressure fuel pump. It shall be appreciated that IMV 104 may also be referred to as a volume control valve, flow control valve, magnetic proportional valve, or various other terms of art. In an embodiment, IMV 104 is a flow control valve, such as an on/off solenoid, integrated into the check valve at the inlet of the pump 106. The flow control valve is electronically controlled by ECU 120 to regulate fuel pressure and provide active inlet metering. The operation and control of such a flow control valve is synchronous with the crankshaft position, and turned on and off with the pump cam to deliver different flow rates.

ECU 120 is in operative communication with and configured to control IMV 104 between a fully closed position which permits minimum fuel flow to fuel pump 106 (e.g., substantially no fuel flow) and a fully open position which permits maximum fuel flow to fuel pump 106. IMV 104 and fuel pump 106 may be configured such that the amount of fuel flow provided by IMV 104 to fuel pump 106 can maintain a desired pressure in one or more components of fuel system 114, such fuel injectors 117 or a rail 108. For example, IMV 104 may be configured such that it can provide fuel to the fuel pump 106 while engine 112 is operating at a testing speed value to maintain a test pressure value in fuel system 114 over a test period. The IMV 104 or other component of fuel system 114 may be employed to measure the amount of fuel provided to fuel pump 106 over the test period.

ECU 120 is also in operative communication with and configured to receive pressure measurements from pressure sensor 119 which is configured to sense pressure of fuel in fuel rail 108. ECU 120 is further in operative communication with and configured to control operation of fuel injectors 118 to inject fuel into combustion cylinders 117 of engine 112.

ECU 120 is an example of a component of an ECS configured and operable to execute operating logic that defines various control, diagnostic, management, and/or regulation functions. For example, the non-transitory memory medium may be configured with instructions executable by the processor to perform a number of acts, evaluations, or operations including those described herein. The operating logic of ECU 120 or other ECS components may be in the form of dedicated hardware, such as a hardwired state machine, analog calculating machine, programming instructions, and/or a different form as would occur to those skilled in the art.

While ECU 120 is depicted as single unit in the illustrated example, it shall be appreciated that one or more processor, one or more non-transitory memory medium, and related components may be provided as or distributed across or among multiple units or physical packages. For example, one or more processors, such as programmable microprocessors or microcontrollers of a solid-state, integrated circuit type which may be provided in one or more control units and can be implemented in any of a number of ways that combine or distribute the control function across one or more control units in various manners. Other components or subsystems of ECU 120 and/or its associated ECS may also be so configured or provided.

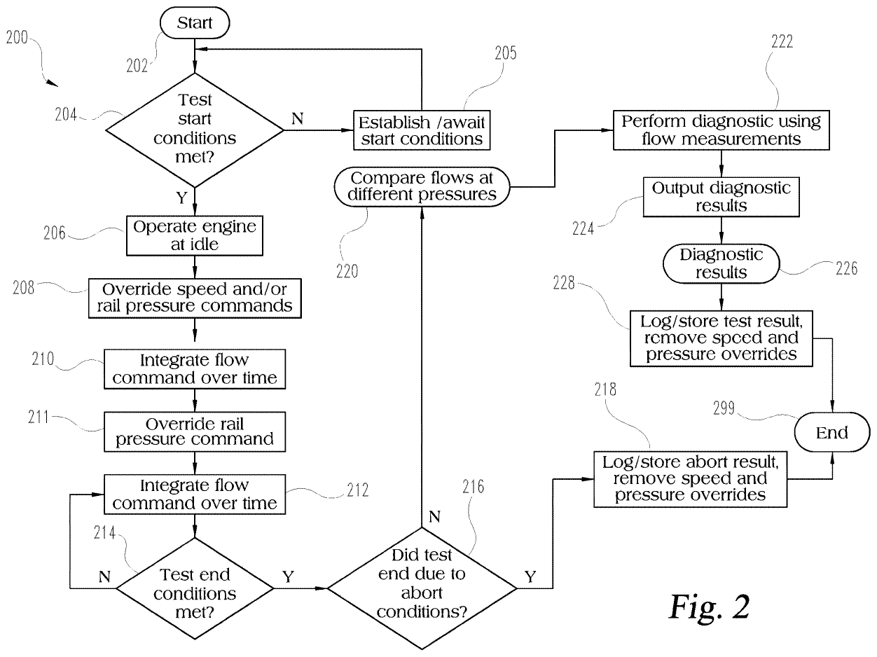

With reference to FIG. 2, there is illustrated an example method 200 which may be implemented and performed, in whole or in part, in connection with a system such as system 100. Method 200 is one example of a method according to the present disclosure for performing a diagnostic or test for leakage of one or more components of fuel system 114.

Method 200 begins at start operation 202 and proceeds to conditional 204 which tests whether one or more test start conditions is or are satisfied. The one or more test start conditions may include a number of conditions which may vary according to the particular system with which method 200 is performed.

The one or more test start conditions may include fuel system conditions which may be established or selected to provide conditions desirable for testing leakage in a fuel system such as fuel system 114. Such conditions may include, for example, a valve such as IMV 104 being open, a pressure sensor such as pressure sensor 119 being operable, a fuel pressure of fuel rail 108 being at a desired value, an engine speed being at an idle speed or testing speed, or other conditions indicative of or suitable as proxies for desired conditions for testing of high pressure portions of a fuel system such as fuel system 114.

In some embodiments, the one or more test start conditions may include an initiation of a test by a technician and/or a diagnostic tool such as diagnostic tool 140. Such embodiments may include, for example, embodiments in which method 200 is performed during a diagnostic, service, or repair event.

In some embodiments, the one or more test start conditions may include a key-on condition and/or one or more engine start conditions. Such embodiments may include, for example, embodiments in which method 200 is performed each time an engine such as engine 112 is started during operation, or on a regular or periodic basis when an engine is already started, or in combination with events such as the detection of error, failure, or fault conditions potentially related to a fuel leakage condition.

If conditional 204 evaluates negative, method 200 proceeds to operation 205 at which method 200 establishes and/or awaits the establishment of the start conditions evaluated by conditional 204. If conditional 204 evaluates affirmative, method 200 proceeds to operation 206 in which engine 112 is operated at idle speed at a nominal fuel flow command and nominal fuel pressure.

From operation 206, method 200 proceeds operation 208 which overrides the fuel pressure command for operating engine 112 at idle conditions. The rail pressure is set to a first test pressure value at or below the nominal fuel pressure at idle conditions. In an embodiment, the engine speed is overridden at idle conditions so the engine speed is elevated above idle speed to a testing speed value. However, it is also contemplated that method 200 does not override the engine speed at idle conditions in some embodiments.

In an example embodiment in which both engine speed and fuel pressure at idle conditions are overridden, the engine speed is elevated from an idle speed to a speed above 1500 RPM. In an example, the first test pressure value is at least 10% lower than a nominal fuel system pressure at idle conditions. Operation 208 may open an IMV, such as IMV 104, to provide the required desired amount or rate of fuel flow to a pump such as fuel pump 106, for example, to maintain the fuel system pressure at, or within a predetermined distance from, the first test pressure value while the engine operates at the testing speed value.

From operation 208, method 200 proceeds to operation 210 which integrates the fuel flow command to the fuel pump 106 provided during operation 208 in order to determine the quantity or amount of fuel provided to maintain the fuel system pressure at the first test pressure value over a first test period. In an embodiment, operation 210 includes averaging the fuel flow amount or fuel flow rate provided to fuel pump 106 during operation 208. In an embodiment, operation 210 includes determining the total fuel amount provided to fuel pump 106 during operation 208.

From operation 210, method 200 proceeds to operation 211 which overrides the rail pressure command from operation 208 to operate the fuel system at a second test pressure value greater than the first test pressure value, while the engine is maintained at the testing speed value. As a result, the engine speed is maintained at idle speed, or at an elevated, above idle speed, and the fuel system pressure, such as the rail pressure, is set to an increased pressure associated with the second test pressure value. In an example, the second test pressure value is at least twice the first test pressure value. Operation 211 may open an IMV, such as IMV 104, to provide the required desired amount or rate of fuel flow to a pump such as fuel pump 106, for example, to maintain the fuel system pressure at, or within a predetermined distance from, the second test pressure value during the second test period.

From operation 211, method 200 proceeds to operation 212 which integrates the fuel flow command to fuel pump 106 during operation 211 to determine the quantity of fuel provided to maintain the fuel system pressure at the second test pressure value over the second test period. In an embodiment, operation 212 includes averaging the fuel flow amount or fuel flow rate provided to fuel pump 106 during operation 211. In an embodiment, operation 212 includes determining the total fuel amount provided to fuel pump 106 during operation 211.

From operation 212, method 200 proceeds to conditional 214 which evaluates whether one or more test end conditions are met. The one or more test end conditions may include, for example, a rail pressure being maintained within a certain range of the first and second test pressure values, the engine speed being maintained within a certain range of the testing speed value, a duration of the test period being above a threshold, a number of pressure or flow measurements during the test periods above a threshold or other metric, or various combinations thereof. A test end condition may also may occur due to some problem requiring the test sequence to be aborted. If conditional 214 evaluates negative, method 200 proceeds to operation 212.

If conditional 214 evaluates affirmative, method 200 proceeds to conditional 216 which evaluates whether a test abort condition was met at conditional 214ue. If conditional 216 evaluates affirmative, method 200 proceeds to operation 218 which logs or stores a test abort condition and information associated therewith (e.g., an indication or reason why the test was aborted), and removes any other test overrides so that engine and fueling operations can resume at nominal values.

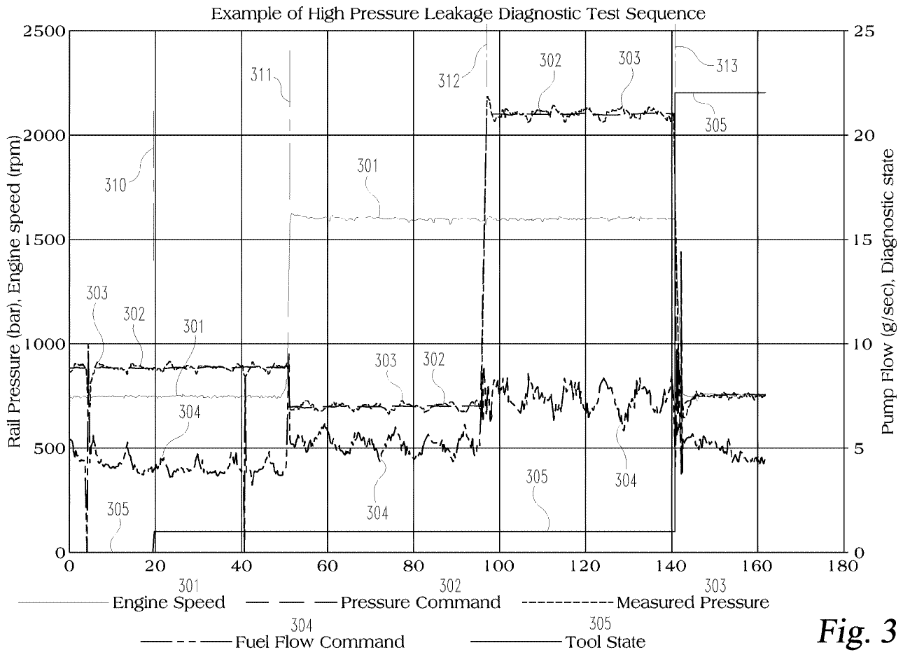

If conditional 216 evaluates negative, the fuel flow measurements or determinations from operations 210, 212 may be provided to operation 220, which compares the fuel flow measurements taken during operations 210, 212 at the different first and second test pressure values. The operation 222 performs one or more diagnostics based on the comparison of the fuel flow measurements from operation 220. The one or more diagnostics may include a number of diagnostics such as those described in connection with FIG. 3. For example, a leakage condition can be determined in response to a fuel amount to fuel pump 106 during the second test period exceeding the fuel amount to fuel pump 106 during the first test period. In an embodiment, the fuel amounts are average fuel amounts or fueling rates over the first and second test periods.

From operation 222, method 200 proceeds to operation 224 which outputs one or more diagnostic results 226 of the one or more diagnostics performed by operation 222. Outputting the one or more diagnostic results 226 may include communicating, displaying, transmitting, storing, or otherwise outputting the one or more diagnostic results 226.

Method 200 proceeds at operation 228 which logs or stores test results such as diagnostic results 226 or other operation associated therewith (e.g., test date and time and/or other diagnostic information associated with the test), removes any other test overrides, and allows the engine operation to continue uninhibited by method 200. From operation 218 or operation 228, method 200 proceeds to end operation 299 and may be subsequently called or repeated.

With reference to FIG. 3, there is illustrated a graph 300 depicting several operational parameters of a system such as system 100 in connection with a diagnostic or test such as the diagnostic or test of method 200. The diagnostic or test can be ran in a service bay environment, or during operation of engine 112 on the road or in the field. Graph 300 depicts engine speed 301, pressure command 302, measured pressure 303, fuel flow command 304 to the fuel pump, and tool or test status 305. Graph 300 depicts engine speed (rpm) 301 on the vertical axis as a function of time(s) on the horizontal axis. Engine speed 301 may be, for example, the operating speed of engine 112.

Graph 300 also depicts the commanded fuel pressure (Bar) 302 and the measured fuel rail pressure (Bar) 303 on the vertical axis as a function of time(s) on the horizontal axis. The pressure of fuel system 114 may be measured, for example, by pressure sensor 119. The pressure of fuel system 114 may be determined at, for example, fuel rail 108. Graph 300 also depicts the fuel flow command 304 on the vertical axis as a function of time(s) on the horizontal axis. The fuel flow command 304 may be for example, the flow rate (mg/second), flow amount, or percent of maximum open position of IMV 104 that is provided to maintain the pressure command 302 while operating engine 112 at an engine testing speed value. The operations of the underlying system and method of graph 300 may be further understood relative to times 310, 311, 312, and 313 which are indicated with dashed vertical lines.

Prior to time 310, the test status 305 is off, engine speed 301 is at idle speed, and the pressure command 302 and fuel flow command 304 are set at nominal speed and fuel flow values in order to operate engine 112 at idle speed conditions. At time 310, test status 305 is set to “on”. At time 310, a fuel system leakage test or diagnostic is triggered, for example, by a diagnostic tool such as diagnostic tool 140 in operative communication with an engine, such as engine 112. The test or diagnostic, such as discussed above with respect to method 200, is ran during at least two test periods between time 310 and time 313. After time 313, test status 305 is set to “complete” and a diagnostic decision is returned.

At time 311, an ECU, such as ECU 120, controls the engine, such as engine 112, to increase engine speed 301 to a testing speed value that is above the idle speed at which engine operation was conducted prior to time 311. Accordingly, the nominal engine speed commands for idle operation of engine 112 are overridden. However, as discussed above, testing at idle speed is also contemplated. In addition, the fuel pressure command 302 is set at a first test pressure value that is lower than the nominal fuel pressure command 302 used for idle operation of engine 12 before time 311. Accordingly, the nominal fuel pressure commands for idle operation of engine 112 are overridden.

Between time 311 and time 312, measured fuel pressure 303 is maintained at or near the first test pressure value, while the fuel flow command 304 to the fuel pump 106 is integrated to measure the amount of fuel provided between times 311, 312 in order to maintain fuel pressure at or near the first test pressure value. One or more pressure and fuel amount measurements may be taken during engine operations between times 311, 312.

At time 312, an ECU, such as ECU 120, sets the fuel pressure command 302 at a second test pressure value that is higher than the first test pressure value at which fuel system 114 was operated between times 311 and 312. According, the fuel pressure commands used for idle operation of engine 12 and for the first test period are still overridden. In an example, the second test pressure value is at least twice as great as the first test pressure value. However, the ECU controls the engine to maintain engine speed at the testing speed value at which engine operation was conducted between times 311 and 312.

Between time 312 and time 313, measured fuel pressure 303 is maintained at or near the second test pressure value, while the fuel pressure command 304 to fuel pump 106 is integrated to measure the amount of fuel provided between times 312, 312 in order to maintain fuel pressure at or near the second test pressure value. One or more pressure and fuel amount measurements may be taken during operation between times 312, 313.

At time 313, test status 305 is set to “complete” and a diagnostic decision is returned. In an embodiment, the diagnostic integrates a first fuel flow command during the first test period to determine the first fuel amount and integrates a second fuel flow command over the second test period to determine the second fuel amount. In an embodiment, the diagnostic determines an average fuel rate for each of the first and second time periods. Since the engine speed is maintained at a constant speed over both test periods, fuel consumption should be constant regardless of fuel system pressure. Therefore, a leakage condition is indicated if the fuel consumption increases during the second test period as compared to the first test period.

In an embodiment, the diagnostic decision compares an average of the first fuel amount provided over the first test period to an average of the second fuel amount provided over the second test period to evaluate whether a leakage of the fuel system increases during the second test period. In an embodiment, a leakage condition is diagnosed in response to the average of the second fuel amount exceeding the average of the first fuel amount by more than a threshold amount.

It shall be appreciated that the methodology described in connection with FIGS. 2-3 are examples for identifying leakage conditions of a fuel system. Once such information is identified a number analytics and diagnostics may be performed including, for example, comparing or evaluating average fuel amounts for multiple (two or more) test periods across one test events, and comparing or evaluating multiple average fuel amounts for multiple test periods across multiple test events. A number of statistics including variances, weighted averages, and other statistics as will occur to one of skill in the art may also be utilized. Furthermore, as noted above such analytics and diagnostics may be performed by or in connection with operation 222 of method 200.

The present disclosure provides testing and/or diagnosis of fuel system leakage failures using the ECU 120 and/or service tool 140. Leakage can be detected with no mechanical alteration of the fuel system 114 or engine 112, and can be conducted without a test drive of the vehicle. In addition, fuel system repairs can be verified in the shop without a test drive. As a result, in-shop repair time for fuel systems is reduced along with the likelihood of repeat visits. Also, the component or components to be replaced during repairs can be better identified, reducing un-needed repair/replacement of fuel system components. Therefore, better service can be provided in response to low rail pressure and aftertreatment fault codes, and symptom-based complaints related to low power, poor acceleration, smoke, etc.

The present disclosures provides a system, method, and/or apparatus within the ECU and/or diagnostic tool which work together to manage overrides, coordinate a specific test sequence and analyze data to produce a clear diagnostic pass/fail result. In an embodiment, high pressure fuel pump flow demand is analyzed using multiple metrics to measure the relative flow at multiple test pressure values. If the fuel flow required to maintain pressure is substantially larger at a higher test pressure value than at a lower test pressure value, a failure decision is made and reported. Performing the testing with the engine idle conditions with larger differential between test pressure values creates the highest ratio of signal-to-noise for detecting excess fuel flow at higher pressures. The test parameters can be configured to accommodate varying numbers of injectors, varying high fuel pressure hardware configurations, and different engine applications/operating conditions.

Testing at unloaded, low speed conditions for the engine also reduces the risk of interference from mechanical factors in the fuel system, such as filter restrictions. The high pressure system performance can be isolated from other fuel system components. The test period durations can be configured to reduce noise caused by engine operation variation and to reduce total test time requirements. By comparing flow amounts at two (or more) different test pressure values, rather than measuring absolute flow requirements, diagnostic variation caused by fuel supply components and the IMV can be mitigated. In addition, comparing two fuel amounts at different test pressure values in rapid succession reduces diagnostic variation caused by thermal variation in fuel and hardware component behavior.

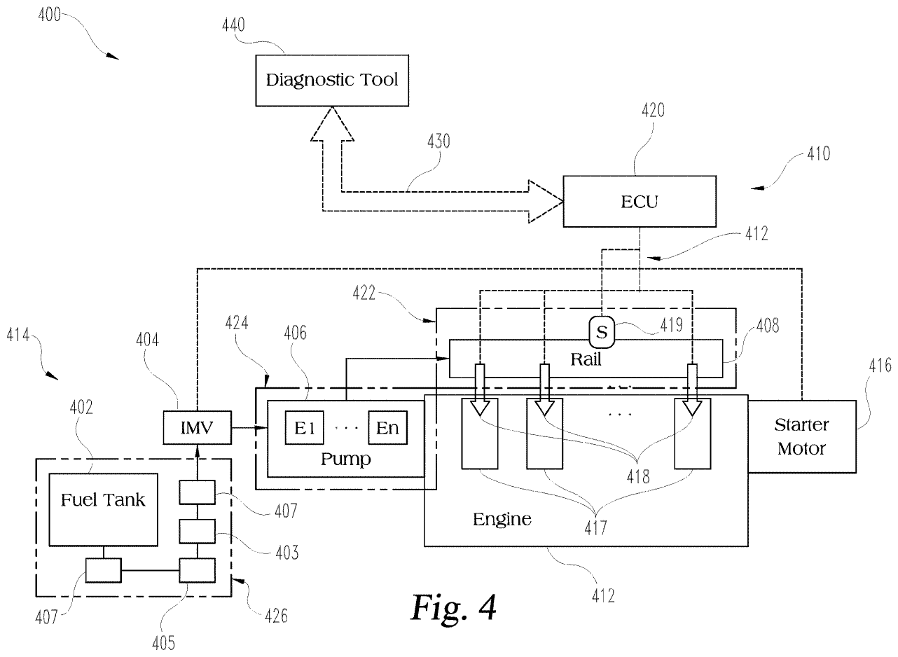

With reference to FIG. 4, there is illustrated another embodiment system 400 including a diagnostic tool 440 and an engine system 410. The diagnostic tool 440 may be similar to diagnostic tool 140, and may be selectably operatively coupled with and in operative communication with an electronic control unit (ECU) 420 of engine system 410 via one or more communication links 430. Diagnostic tool 440 and communication links 430 may be provided in a number of forms.

In some embodiments, diagnostic tool 440 may be implemented and executed in connection with one or more computing devices present at the location of engine system 410 (e.g., at a service bay or another point-of-service at which engine system 410 is located). In such embodiments, communication links 430 may include one more physical connections with engine system 410, for example, via an OBD II interface, a J1939 interface, or various other interfaces.

In some embodiments, diagnostic tool 440 may be implemented and executed in connection with one or more computing devices located remotely from engine system 410 and communication links 430 may include one more networks including wired and/or wireless networks or network components configured and operable to provide communication between diagnostic tool 440 and ECU 420 of engine system 410. Some such embodiments may include one or more computing devices located remotely from engine system 410 and in communication with ECU 420 of engine system 410 via a telematics system. Some such embodiments may include a combination of one or more computing devices located remotely from engine system 410 and one or more computing devices present at the location of engine system 410 (e.g., at a service bay or another point-of-service at which engine system 410 is located).

While diagnostic tool 440 is depicted in FIG. 4 as external to engine system 410, on some embodiments, diagnostic tool 440 may be embedded or otherwise provide in engine system 410. In some such embodiments, diagnostic tool 440 may be embedded or otherwise provide in and executed by ECU 420 and/or other components of an electronic control system (ECS) of engine system 410. In some such embodiments communication links 430 may include one or more intra-ECU or intra-ECS communication channels or may be omitted in instances where a communication link is not required.

Engine system 410 further includes an engine 412, a starter motor 416 operatively coupled with engine 412 and ECU 420, and a fuel system 414 operatively coupled with engine 412 and ECU 420. In the illustrated embodiment engine 412 is a direct-injection, reciprocating piston-type internal combustion engine configured and operable to combust fuel injected by one or more fuel injectors 418 directly into one respective ones of a plurality of combustion cylinders 417. ECU 420 is further in operative communication with and configured to control operation of fuel injectors 418 to inject fuel into combustion cylinders 417 of engine 412. It shall be appreciated that engine 412 may be configured and provided in various forms, including various numbers of combustion cylinders 417 and various numbers of fuel injectors 418.

In the illustrated embodiment, fuel system 414 is configured and provided as a high-pressure common-rail (HPCR) fuel system. In other embodiments, fuel system 414 may be provided in various other forms as will occur to one of skill in the art with the benefit and insight of the present disclosure, including gasoline direct injection systems, and/or systems for injecting liquid fuel, gaseous fuel, and combinations thereof.

In the illustrated embodiment, fuel system 414 includes a first portion 422, a second portion 424, and a third portion 426. It is further contemplated herein that fuel system 414 may be divided into just two portions, or into four or more portions, in accordance with the present disclosure.

In an embodiment, first portion 422 includes a fuel rail 408 which receives pressurized fuel from a fuel pump 406 and provides pressurized fuel to fuel injectors 418. First portion 422 may also include other components and associated plumbing, such as check valves to admit fuel flow from fuel pump 406, a pressure relief valve on fuel rail 408, injector and fuel rail drain lines, and a drain manifold for collecting fuel that is drained from first portion 422.

In an embodiment, second portion 424 includes fuel pump 406. In the illustrated embodiment, fuel pump 406 is provided and configured as a high pressure fuel pump and includes one or more pump elements (E1 . . . En) such as piston-in-cylinder-type pump elements configured to pressurize fuel received by fuel pump 406. Fuel pump 406 provides pressurized fuel to first portion 422 of fuel system 414.

In an embodiment, third portion 426 includes a fuel tank 402, a low pressure fuel pump 403 upstream of fuel pump 406, priming pump 405 upstream of low pressure pump 403, and fuel filters 407. Fuel from fuel tank 402 is provided from third portion 426 to second portion 424. In an embodiment, third portion 426 is a low or lower pressure supply portion of fuel system 414 that provides fuel to fuel pump 406.

In an embodiment, an inlet metering valve (IMV) 404 is provided at or upstream from an inlet to fuel pump 406 of second portion 424 and is operatively coupled with and controllable by ECU 420 to meter or regulate flow of fuel into fuel pump 406. IMV 404 is configured and operable to received fuel pumped from fuel tank 402 by pump 403 of third portion 426. It shall be appreciated that IMV 404 may also be referred to as a volume control valve, flow control valve, magnetic proportional valve, or various other terms of art. In an embodiment, IMV 404 is a flow control valve, such as an on/off solenoid, integrated into the check valve at the inlet of the pump 406. The flow control valve is electronically controlled by ECU 420 to regulate fuel pressure and provide active inlet metering. The operation and control of such a flow control valve is synchronous with the crankshaft position, and turned on and off with the pump cam to deliver different flow rates.

ECU 420 is in operative communication with and configured to control IMV 404 between a fully closed position which permits minimum fuel flow to fuel pump 406 (e.g., substantially no fuel flow) and a fully open position which permits maximum fuel flow to fuel pump 406. IMV 404 and fuel pump 406 may be configured such that the amount of fuel flow provided by IMV 404 to fuel pump 406 can maintain a desired pressure in one or more components of first portion 422 of fuel system 414, such fuel injectors 417 or a rail 408.

For example, IMV 404 may be configured such that it can provide fuel to the fuel pump 406 while engine 412 is operating at a testing speed value to maintain a test pressure value in first portion 422 of fuel system 414 over a test period. The IMV 404 or other component of fuel system 414 may be employed to measure the amount of fuel provided to fuel pump 406 over the test period. ECU 420 is also in operative communication with and configured to receive pressure measurements from pressure sensor 419 which is configured to sense pressure of fuel in fuel rail 408. In another example, IMV 404 may be configured such that it can overfill the fuel pump 406 a low engine speeds or during engine cranking with starter 416 such as during testing of fuel pump 406.

Examples of a diagnostic test for first portion 422 of fuel system 414 is provided in the discussion above with respect to FIGS. 1-3. Examples of a diagnostic test for second portion 422 of fuel system 414 including fuel pump 406 is provided in International Patent App. No. PCT/US24/15457 filed Feb. 13, 2024, and U.S. Provisional App. Ser. No. 63/485,546 filed on Feb. 17, 2023, which are incorporated herein by reference.

ECU 420 is an example of a component of an ECS configured and operable to execute operating logic that defines various control, diagnostic, management, and/or regulation functions. For example, the non-transitory memory medium may be configured with instructions executable by the processor to perform a number of acts, evaluations, or operations including those described herein. The operating logic of ECU 420 or other ECS components may be in the form of dedicated hardware, such as a hardwired state machine, analog calculating machine, programming instructions, and/or a different form as would occur to those skilled in the art.

While ECU 420 is depicted as single unit in the illustrated example, it shall be appreciated that one or more processors, one or more non-transitory memory media, and related components may be provided as or distributed across or among multiple units or physical packages. For example, one or more processors, such as programmable microprocessors or microcontrollers of a solid-state, integrated circuit type which may be provided in one or more control units and can be implemented in any of a number of ways that combine or distribute the control function across one or more control units in various manners. Other components or subsystems of ECU 420 and/or its associated ECS may also be so configured or provided.

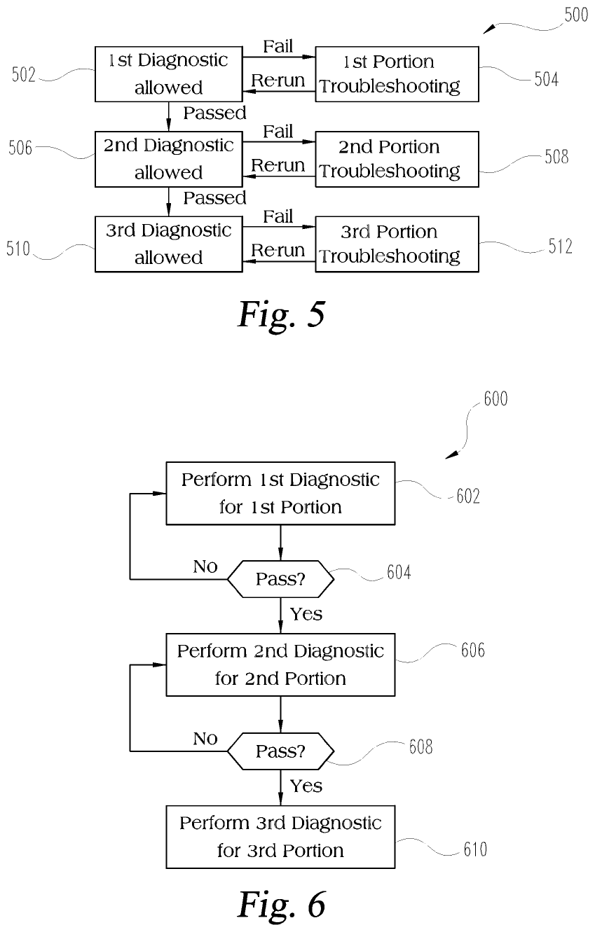

With reference to FIG. 5, there is illustrated an example diagnostic management process 500 which may be implemented and performed, in whole or in part, in connection with a system such as system 400. Process 500 is one example according to the present disclosure for managing performance of diagnostic tests for each of the first portion 422, second portion 424, and third portion 426 of fuel system 414 with ECU 420 alone or in conjunction with service tool 440 while system 400 is out-of-mission, such as in a service bay for troubleshooting and repair of fuel system 414.

Process 500 includes a first test block 502 in which a first diagnostic is allowed by ECU 420 for first portion 422 of fuel system 414. ECU 420 allows the first diagnostic if, for example, fuel system conditions are established or selected to provide conditions desirable for testing for leakage in first portion 422 of fuel system 414. Such conditions may include, for example, an absence of IMV circuit open/short, an absence of a pressure signal circuit open/short, the absence of one or more failures that normally activate a malfunction indicator light (MIL) on the dashboard or other location, engine temperature, fuel tank level and/or other conditions indicative of or suitable as proxies for desired conditions for testing of high pressure first portion 422 of fuel system 414.

In some embodiments, the one or more test start conditions may include an initiation of a test by a technician and/or a diagnostic tool such as diagnostic tool 440. Such embodiments may include, for example, embodiments in which process 500 is performed during a diagnostic, service or repair event using diagnostic tool 440 while the testing sequence is managed by ECU 420.

If the first diagnostic fails at test block 502, process 500 continues at troubleshooting block 504 to troubleshoot and repair or replace any components of first portion 422 that caused the diagnostic failure. Once the troubleshooting is complete, process 500 returns to test block 502 to re-run the diagnostic of first portion 422. If the diagnostic fails again, the troubleshooting and re-running of the first diagnostic are repeated until a pass decision is made for first portion 422 of fuel system 414.

Process 500 includes a second test block 506 in which a second diagnostic is allowed for second portion 424 of fuel system 414 only after a pass decision is made from test block 502. In an embodiment, the second diagnostic is only allowed if the first diagnostic at first test block 502 was passed within a certain recency of initiating process 500. For example, the second diagnostic at second test block 506 may only be allowed if the first diagnostic at first test block 502 passed within a predetermined number of key-on or engine start events of system 400.

The second diagnostic at second test block 506 may additionally only be allowed if, for example, fuel system conditions are established or selected to provide conditions desirable for testing for testing a fuel pump such as fuel pump 406. Such conditions may include, for example, an absence of IMV circuit open/short, an absence of a pressure signal circuit open/short, the absence of one or more failures that normally activate a malfunction indicator light (MIL) on the dashboard or other location, engine temperature, fuel tank level and/or other conditions indicative of, or suitable as proxies for, a depressurized condition of high pressure first portion 422 of fueling system 414. In some embodiments, the one or more test start conditions for second test block 506 may include a request for initiation of a second test by a technician and/or a diagnostic tool such as diagnostic tool 440 that is granted by ECU 420 only if a pass decision is made at first test block 502.

If the second diagnostic fails at second test block 506, process 500 continues at troubleshooting block 508 to troubleshoot and repair or replace any components of second portion 424 that caused the diagnostic failure. Once the troubleshooting is complete, process 500 returns to second test block 506 to re-run the diagnostic of second portion 424. If the second diagnostic at second test block 506 fails again, the troubleshooting and re-running of the second diagnostic are repeated until a pass decision is made for second portion 424 of fuel system 414.

Process 500 includes a third test block 510 in which a third diagnostic is allowed for third portion 426 of fuel system 414 only after a pass decision is made from second test block 506. In an embodiment, the third diagnostic is only allowed if the second diagnostic at second test block 506 was passed within a certain recency of initiating process 500. For example, the third diagnostic at third test block 510 may only be allowed if the first diagnostic at first test block 502 and the second diagnostic at second test block 506 passed within a predetermined number of key-on or engine start events of system 400.

If the third diagnostic fails at third test block 510, process 500 continues at troubleshooting block 512 to troubleshoot and repair or replace any components of third portion 426 that caused the diagnostic failure. Once the troubleshooting is complete at troubleshooting block 512, process 500 returns to third test block 510 to re-run the diagnostic of third portion 426. If the third diagnostic fails again, the troubleshooting and re-running of the third diagnostic are repeated until a pass decision is made for third portion 426 of fuel system 414.

Referring to FIG. 6, a method 600 for managing the testing sequence of fuel system 414 is provided. Method 600 includes an operation 602 to perform a first diagnostic on first portion 422 of fuel system 414. Method 600 continues at conditional 604 to determine if first portion 422 passed the first diagnostic. If conditional 602 is NO, method 600 returns to operation 602 to continue diagnostics and troubleshooting of first portion 422 of fuel system 414.

If conditional 604 is YES, process 600 continues at operation 604 to perform a second diagnostic on second portion 424 of fuel system 414. Method 600 continues at conditional 608 to determine if second portion 424 passed the second diagnostic. If conditional 608 is NO, method 600 returns to operation 606 to re-run the second diagnostic and continue troubleshooting of second portion 424 of fuel system 414.

If conditional 608 is YES, process 600 continues at operation 610 to perform a third diagnostic on third portion 426 of fuel system 414. Method 600 can continue re-running the third diagnostic on third portion 426 until it passes the third diagnostic.

It shall be appreciated that the methodology described in connection with FIGS. 5-6 are examples for identifying and troubleshooting components of a fuel system for repair or replacement. A number analytics and diagnostics may be performed in order to troubleshoot each portion 422, 424, 426 of fuel system 414. Furthermore, as noted above such analytics and diagnostics are performed in a proscribed order to eliminate or reduce diagnostic noise caused by hardware failures which can be eliminated before proceeding to the next diagnostic.

The present disclosure provides management of testing and/or diagnosis of fuel system failures within multiple portions of fuel system 414 using the ECU 420. In addition, fuel system repairs can be verified in the shop for each portion of fuel system 414 without a test drive. As a result, in-shop repair time along with unnecessary component replacement and repair for fuel systems is reduced along with the likelihood of repeat visits. Also, the component or components to be repaired or replaced during service can be better identified, reducing un-needed repair/replacement of fuel system components. Therefore, better service can be provided in response to low rail pressure and aftertreatment fault codes, fuel pump fault codes and performance issues, and symptom-based complaints related to low power, poor acceleration, smoke, etc.

The present disclosure provides a system, method, and/or apparatus within the ECU 420 which work to prevent unauthorized overrides in testing sequence and priority during servicing of fuel system 414. A specific test sequence is imposed to first test well-isolated hardware components of the fuel system 414 before more complex diagnostics are run to produce a clear diagnostic pass/fail result for each portion 422, 424, 426 of the fuel system 414 before moving to the next diagnostic for the next portion 422, 424, 426 of fuel system 414. The recency of testing for each portion of fuel system 414 is tracked in order to determine whether to enable testing of a next portion of fuel system 414. The test parameters can be configured to accommodate varying numbers of injectors, varying high fuel pressure, fuel pump, and low fuel pressure hardware configurations, and different engine applications/operating conditions.

As illustrated by this detailed description, the present disclosure contemplates multiple and various embodiments, including, without limitation, the following example embodiments. A first example embodiment is a method of testing a fuel system of an engine. The method includes operating the engine at idle conditions; setting an engine speed to a testing speed value and setting a fuel system pressure at a first test pressure value for a first test period; determining a first fuel amount provided during the first test period; setting the fuel system pressure to a second test pressure value for a second test period while maintaining the engine speed at the testing speed value; determining a second fuel amount provided during the second test period; and diagnosing a condition of the fuel system in response to the first fuel amount and the second fuel amount.

A second example embodiment includes the features of the first example embodiment, and removing the testing speed value and the second test pressure value at the end of the second test period to operate the engine.

A third example embodiment includes the features of the first example embodiment, wherein the diagnosing comprises comparing an average of the first fuel amount provided to a fuel pump of the engine over the first test period to an average of the second fuel amount provided to the fuel pump over the second test period to evaluate whether a leakage of the fuel system increases during the second test period.

A fourth example embodiment includes the features of the third example embodiment, wherein a leakage condition is diagnosed in response to the average of the second fuel amount exceeding the average of the first fuel amount by more than a threshold amount.

A fifth example embodiment includes the features of the fourth example embodiment, wherein the first test pressure value is less than a nominal fuel pressure at idle conditions.

A sixth example embodiment includes the features of any one of the first through fifth example embodiments, wherein the method is performed during an out-of-mission service event.

A seventh example embodiment includes the features of any one of the first through fifth example embodiments, wherein the method is performed during an in-mission engine event.

An eighth example embodiment is a system comprising: an engine system including a fuel system and an electronic control unit (ECU) configured to perform operations to: operate the engine at idle conditions; set an engine speed to a testing speed value and set a fuel system pressure at a first test pressure value for a first test period; determine a first fuel amount provided during the first test period; set the fuel system pressure to a second test pressure value for a second test period while maintaining the engine speed at the testing speed value; determine a second fuel amount provided during the second test period; and provide the first fuel amount and the second fuel amount to diagnose a condition of the fuel system based on the first fuel amount and the second fuel amount.

A ninth example embodiment includes the features of the eighth example embodiment, wherein the ECU is configured to perform operations to override engine speed and fuel system pressure commands associated with the idle conditions during the first test period and the second test period.

A tenth example embodiment includes the features of the eighth example embodiment, wherein the ECU is configured to perform operations to integrate a first fuel flow command to a fuel pump of the engine during the first test period to determine the first fuel amount and integrate a second fuel flow command to the fuel pump over the second test period to determine the second fuel amount.

An eleventh example embodiment includes the features of any one of the eighth through tenth example embodiments, wherein the ECU is operatively coupled with an external diagnostic tool.

A twelfth example embodiment includes the features of any one of the eighth through tenth example embodiments, wherein the fuel system is a high-pressure, common-rail fuel system.

A thirteenth example embodiment includes the features of any one of the eighth through tenth example embodiments and includes a gasoline direct injection engine with a fuel rail configured to receive pressurized fuel from the pump and a pressure sensor configured to measure fuel pressure of the fuel rail.

A fourteenth example embodiment is an apparatus for testing a fuel system of an engine, the apparatus comprising: a non-transitory memory medium configured to store instructions executable by a processor to perform the acts of: operating the engine at idle conditions; set an engine speed to a testing speed value and setting a fuel system pressure at a first test pressure value for a first test period; determining a first fuel amount provided during the first test period; setting the fuel system pressure to a second test pressure value for a second test period while maintaining the engine speed at the testing speed value; determining a second fuel amount provided during the second test period; and diagnosing a condition of the fuel system in response to the first fuel amount and the second fuel amount.

A fifteenth example embodiment includes the features of the fourteenth example embodiment, wherein the act of diagnosing comprises comparing an average of the first fuel amount provided to a fuel pump of the engine over the first test period to an average of the second fuel amount provided to the fuel pump over the second test period to evaluate whether a leakage of the fuel system increases during the second test period.

A sixteenth example embodiment includes the features of the fifteenth example embodiment, wherein the act of diagnosing comprises determining a leakage condition in the fuel system is present in response to the average of the second fuel amount exceeding the average of the first fuel amount by more than a threshold amount.

A seventeenth example embodiment includes the features of the fourteenth example embodiment, wherein non-transitory memory medium configured to store instructions is executable by the processor to perform the acts of overriding engine speed and fuel system pressure commands associated with the idle conditions during the first test period and the second test period.

An eighteenth example embodiment includes the features of the fourteenth example embodiment, wherein non-transitory memory medium configured to store instructions is executable by the processor to perform the acts of integrating a first fuel flow command to a fuel pump of the engine during the first test period to determine the first fuel amount and integrating a second fuel flow command to the engine over the second test period to determine the second fuel amount.

A nineteenth example embodiment includes the features of any one of the fourteenth through eighteenth example embodiments, wherein the instructions are configured to operate during an out-of-mission service event.

A twentieth example embodiment includes the features of any one of the fourteenth through eighteenth example embodiments, wherein the instructions are configured to operate during an in-mission engine event.

A twenty-first example embodiment is a method of testing a fuel system of an engine. The method includes performing a first diagnostic on a first portion of the fuel system; in response to passing the first diagnostic, enabling a second diagnostic on a second portion of the fuel system; performing the second diagnostic on the second portion of the fuel system; in response to passing the second diagnostic, enabling a third diagnostic on a third portion of the fuel system; and performing the third diagnostic on the third portion of the fuel system.

A twenty-second example embodiment includes the features of the twenty-first example embodiment, and enabling of the second diagnostic and the third diagnostic is controlled in an electronic control unit of the engine.

A twenty-third example embodiment includes the features of the twenty-second example embodiment, and includes storing a diagnostic history for each of the first diagnostic on the first portion, the second diagnostic on the second portion, and the third diagnostic on the third portion in a memory of the electronic control unit.

A twenty-fourth example embodiment includes the features of the twenty-third example embodiment, and enabling the second diagnostic requires the first diagnostic to have been passed within a predetermined number of start cycles for the engine, a predetermined engine run time, and/or a key on time.

A twenty-fifth example embodiment includes the features of the twenty-fourth example embodiment, and enabling the third diagnostic requires the second diagnostic to have been passed within a predetermined number of start cycles for the engine.

A twenty-sixth example embodiment includes the features of any one of the twenty-first through twenty-fifth example embodiments, wherein the method is performed during an out-of-mission service event.

A twenty-seventh example embodiment includes the features of any one of the twenty-first through twenty-sixth example embodiments, wherein the first portion of the fuel system is a high pressure portion of the system that includes a common rail connected to fuel injectors of the engine; the second portion of the fuel system is a high pressure pump portion of the fuel system including a high pressure pump connected to the common rail; and the third portion of the fuel system is a low pressure portion of the fuel system including a low pressure pump connected to the high pressure pump.

A twenty-eighth example embodiment is a system comprising: an engine system including a fuel system and an electronic control unit (ECU) configured to perform operations to: perform a first diagnostic on a first portion of the fuel system; in response to passing the first diagnostic, enable a second diagnostic on a second portion of the fuel system; perform the second diagnostic on the second portion of the fuel system; in response to passing the second diagnostic, enable a third diagnostic on a third portion of the fuel system; and perform the third diagnostic on the third portion of the fuel system.

A twenty-ninth example embodiment includes the features of the twenty-eighth example embodiment, wherein the ECU is configured to store a diagnostic history for each of the first portion, second portion, and third portion of the fuel system in a memory of the electronic control unit.

A thirtieth example embodiment includes the features of the twenty-eighth example embodiment, wherein the ECU is configured to the ECU is configured to: enable the second diagnostic only if the first diagnostic has passed within a predetermined number of start cycles for the engine, a predetermined engine run time, and/or a key on time; and enable the third diagnostic only if the second diagnostic has passed within a predetermined number of start cycles for the engine, a predetermined engine run time, and/or a key on time.

A thirty-first example embodiment includes the features of any one of the twenty-eighth through thirtieth example embodiments, wherein the ECU is operatively coupled with an external diagnostic tool.

A thirty-second example embodiment includes the features of any one of the twenty-eighth through thirtieth example embodiments, wherein the fuel system is a high-pressure, common-rail fuel system or a gasoline direct injection system.

A thirty-third example embodiment includes the features of any one of the twenty-eighth through thirtieth example embodiments and the first portion of the fuel system is a high pressure portion of the fuel system that includes a common rail connected to fuel injectors of the engine; the second portion of the fuel system is a high pressure pump portion of the fuel system including a high pressure pump connected to the common rail; and the third portion of the fuel system is a low pressure portion of the fuel system including a low pressure pump connected to the high pressure pump.

A thirty-fourth example embodiment is an apparatus for testing a fuel system of an engine, the apparatus comprising: a non-transitory memory medium configured to store instructions executable by a processor to perform the acts of: perform a first diagnostic on a first portion of the fuel system; in response to passing the first diagnostic, enable a second diagnostic on a second portion of the fuel system; perform the second diagnostic on the second portion of the fuel system; in response to passing the second diagnostic, enable a third diagnostic on a third portion of the fuel system; and perform the third diagnostic on the third portion of the fuel system.

A thirty-fifth example embodiment includes the features of the thirty-fourth example embodiment, and the non-transitory memory medium configured to store instructions is executable by the processor to perform the acts of: store a diagnostic history for each of the first portion, second portion, and third portion of the fuel system in the non-transitory memory medium.

A thirty-sixth example embodiment includes the features of the thirty-fifth example embodiment, and the non-transitory memory medium configured to store instructions is executable by the processor to perform the acts of: enable the second diagnostic only if the first diagnostic has passed within a predetermined number of start cycles for the engine, a predetermined engine run time, and/or a key on time; and enable the third diagnostic only if the second diagnostic has passed within a predetermined number of start cycles for the engine, a predetermined engine run time, and/or a key on time.

A thirty-seventh example embodiment includes the features of any of the thirty-fourth through thirty-sixth embodiments, and the non-transitory memory medium configured to store instructions is executable by the processor to perform the acts of: enforce a sequence that requires passing of the first diagnostic before performing the second diagnostic and requires passing of the second diagnostic before performing the third diagnostic.

A thirty-eighth example embodiment includes the features of any of the thirty-fourth through thirty-seventth embodiments, and the non-transitory memory medium configured to store instructions is executable by the processor to perform the acts of: determine a leakage condition in the first portion of the fuel system with the first diagnostic; determine a high pressure pump condition in the second portion of the fuel system with the second diagnostic; and determine a restriction in the third portion of the fuel system with the third diagnostic.

A thirty-nineth example embodiment includes the features of any one of the thirty-fourth through thirty-eighth example embodiments, and the non-transitory memory medium configured to store instructions is executable by the processor to perform the acts of: operate during an out-of-mission service event of the engine.

A fortieth example embodiment includes the features of any one of the thirty-fourth through thirty-nineth example embodiments, and the non-transitory memory medium configured to store instructions is executable by the processor to perform the acts of: operate on an electronic control unit of the engine.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1-20. (canceled)

21. A method of testing a fuel system of an engine, the method comprising:
performing a first diagnostic on a first portion of the fuel system;
in response to passing the first diagnostic, enabling a second diagnostic on a second portion of the fuel system;
performing the second diagnostic on the second portion of the fuel system;
in response to passing the second diagnostic, enabling a third diagnostic on a third portion of the fuel system; and
performing the third diagnostic on the third portion of the fuel system.

22. The method of claim 21, wherein the enabling of the second diagnostic and the third diagnostic is controlled in an electronic control unit of the engine.

23. The method of claim 22, further comprising storing a diagnostic history for each of the first diagnostic on the first portion, the second diagnostic on the second portion, and the third diagnostic on the third portion in a memory of the electronic control unit.

24. The method of claim 23, wherein enabling the second diagnostic requires the first diagnostic to have been passed within a predetermined number of start cycles for the engine, a predetermined engine run time, and/or a key on time.

25. The method of claim 24, wherein enabling the third diagnostic requires the second diagnostic to have been passed within a predetermined number of start cycles for the engine.

26. The method of claim 21, wherein the method is performed by the electronic control unit during an out-of-mission service event.

27. The method of claim 21, wherein:
the first portion of the fuel system is a high pressure portion of the system that includes a common rail connected to fuel injectors of the engine;
the second portion of the fuel system is a high pressure pump portion of the fuel system including a high pressure pump connected to the common rail; and
the third portion of the fuel system is a low pressure portion of the fuel system including a low pressure pump connected to the high pressure pump.

28. A system comprising:
an engine including a fuel system and an electronic control unit (ECU) configured to perform operations to:
perform a first diagnostic on a first portion of the fuel system;
in response to passing the first diagnostic, enable a second diagnostic on a second portion of the fuel system;
perform the second diagnostic on the second portion of the fuel system;
in response to passing the second diagnostic, enable a third diagnostic on a third portion of the fuel system; and
perform the third diagnostic on the third portion of the fuel system.

29. The system of claim 28, wherein the ECU is configured to store a diagnostic history for each of the first portion, second portion, and third portion of the fuel system in a memory of the electronic control unit.

30. The system of claim 28, wherein the ECU is configured to:
enable the second diagnostic only if the first diagnostic has passed within a predetermined number of start cycles for the engine, a predetermined engine run time, and/or a key on time; and
enable the third diagnostic only if the second diagnostic has passed within a predetermined number of start cycles for the engine, a predetermined engine run time, and/or a key on time.

31. The system of claim 28, wherein the ECU is operatively coupled with an external diagnostic tool.

32. The system of claim 28, wherein the fuel system is a high-pressure, common-rail fuel system or a gasoline direct injection system.

33. The system of claim 32, wherein:
the first portion of the fuel system is a high pressure portion of the fuel system that includes a common rail connected to fuel injectors of the engine;
the second portion of the fuel system is a high pressure pump portion of the fuel system including a high pressure pump connected to the common rail; and
the third portion of the fuel system is a low pressure portion of the fuel system including a low pressure pump connected to the high pressure pump.

34. An apparatus for managing the testing a fuel system of an engine, the apparatus comprising:
a non-transitory memory medium configured to store instructions executable by a processor to perform the acts of:
perform a first diagnostic on a first portion of the fuel system;
in response to passing the first diagnostic, enable a second diagnostic on a second portion of the fuel system;
perform the second diagnostic on the second portion of the fuel system;
in response to passing the second diagnostic, enable a third diagnostic on a third portion of the fuel system; and
perform the third diagnostic on the third portion of the fuel system.

35. The apparatus of claim 34, wherein the non-transitory memory medium configured to store instructions is executable by the processor to perform the acts of:
store a diagnostic history for each of the first portion, second portion, and third portion of the fuel system in the non-transitory memory medium.

36. The apparatus of claim 35, wherein the non-transitory memory medium configured to store instructions is executable by the processor to perform the acts of:
enable the second diagnostic only if the first diagnostic has passed within a predetermined number of start cycles for the engine, a predetermined engine run time, and/or a key on time; and
enable the third diagnostic only if the second diagnostic has passed within a predetermined number of start cycles for the engine, a predetermined engine run time, and/or a key on time.

37. The apparatus of claim 34, wherein the non-transitory memory medium configured to store instructions is executable by the processor to perform the acts of:
enforce a sequence that requires passing of the first diagnostic before performing the second diagnostic and requires passing of the second diagnostic before performing the third diagnostic.

38. The apparatus of claim 34, wherein the non-transitory memory medium configured to store instructions is executable by the processor to perform the acts of:
determine a leakage condition in the first portion of the fuel system with the first diagnostic;
determine a high pressure pump condition in the second portion of the fuel system with the second diagnostic; and
determine a restriction in the third portion of the fuel system with the third diagnostic.

39. The apparatus of claim 34, wherein the non-transitory memory medium configured to store instructions is executable by the processor to perform the acts of: operate during an out-of-mission service event.

40. The apparatus of claim 34, wherein the non-transitory memory medium configured to store instructions is executable by the processor to perform the acts of: operate on an electronic control unit of the engine.
